(19) United States
(12) Patent Application Publication
(10) Pub. No.: US 2009/0000486 A1
(43) Pub. Date: Jan. 1, 2009

(54) Outlet Sleeve of Soft-Drink and Post-Mix Systems

(76) Inventors: Karl Gupper, Dietmannsried (DE); Wieland Reichle, Durach (DE)

Correspondence Address: NOTARO & MICHALOS P.C., 100 DUTCH HILL ROAD, SUITE 110, ORANGEBURG, NY, 10962-2100, US

(21) Appl. No.: 12/097,970

(22) PCT Filed: Dec. 18, 2006
(86) PCT No.: PCT/DE2006/002264

§ 371 Date: Jun. 18, 2008

(30) Foreign Application Priority Data
Dec. 21, 2005 (DE) 202005019748.3

(51) Int. Cl. B67D 1/08

(52) U.S. Cl. 99/275

(57) ABSTRACT

The present invention relates to an outlet sleeve (1) of soft-drink and postmix systems which, in order to prevent the health of users being put at risk, is provided with a closure mechanism (2), in particular an automatic closure mechanism (2).

The present invention relates to an outlet sleeve of soft drink and postmix systems.

Soft drink and postmix systems are utilized for mixing in situ a beverage from water and concentrate. Herein from different storage containers, or from one storage container and a water conduit, are removed syrup and water and mixed before they leave the soft drink or postmix system or they are mixed in a glass. The mixing of both liquids conventionally takes place in a glass, wherein first water flows, subsequently syrup and water simultaneously and, lastly, water alone again for a final cleaning.

Known sleeves of soft drink and postmix systems conventionally comprise conically formed sleeves which are fastened on the soft drink or postmix system by means of a bayonet joint. In the interior of this sleeve is located a syrup outlet nozzle as well as a water outlet device encompassing the latter in the form of a jacket. As a rule, these sleeves are not closed such that, due to the sugar content of the utilized syrup, insects are encouraged to crawl into the interior of the sleeve. When drawing a soft drink, it can occur that these insects are flushed into the glass and, if the buyer of the soft drink does not pay attention, are swallowed by him. Due to stings and swelling in the esophagus, this can result in highly stressful health consequences.

The present invention therefore addresses the problem of further developing said sleeve such that health risks are excluded.

This problem is solved thereby that the outlet sleeve includes a closure mechanism, in particular a self-actingly operating closure mechanism. Hereby to great advantage the penetration of insects into the sleeve according to the invention is prevented. In particular thereby that the closure operates self-actingly, thus opens self-actingly and closes self-actingly, the facility of operating the outlet sleeve according to the invention is markedly improved and manual interventions are advantageously superfluous. Compared to a close-meshed screen, a closure has the advantage that it does not present a hindrance of the liquid stream and does not allow even extremely small creatures to access the interior of the outlet sleeve. According to the invention, the self-acting operation can herein take place through every conceivable force source and every conceivable control, for example in the form of a motor-driven iris diaphragm, a gate valve, a butterfly valve or a screw closure or a volume-variable sealing balloon or the like.

Implementation of the invention provides that the closure mechanism includes an actuation lever in the interior of the outlet sleeve, which can be acted upon by at least one fluid, as well as a force transmitter and a closure.

At very great advantage in this manner a mechanism which is simple to actuate is proposed which utilizes an energy source already provided in any event in the soft drink or postmix system. An additional driving mechanism for the closure mechanism can advantageously be omitted as well as sensor circuitry which acquires the opening and closing time. The kinetic energy of the fluids flowing in the soft drink and postmix system is utilized for the purpose of acting upon the actuation lever which, in turn, conducts the kinetic energy further to a force transmitter, which transfers this energy onto a closure for an opening movement. The actuation lever can herein according to the invention also be implemented as a continuous lever, for example as a paddle wheel, whose individual paddles are sequentially acted upon by fluid. The force transmitter can conduct the energy further in mechanical or electrical form.

An especially simple and yet reliable device is obtained if actuation lever and force transmitter are developed as rigid levers, the force transmitter being configured as a swing arm, with the actuation lever and swing arm being disposed on a swivel axle. This swivel axle is preferably disposed on the sleeve. The rigid connection between actuation lever and closure cap represents a simple mechanical connection which, however, is robust and ensures long maintenance-free service lives. The kinetic energy acting upon the actuation lever can be transferred nearly loss-free by means of the rigid swing arm onto the closure cap. Thereby that the swivel axle is provided on the sleeve, a device with short layout with the greatest possible reduction of the stroke of the moving masses is obtained.

A further implementation of the invention provides that in the proximity of the swivel axle a weight is disposed. This weight makes available the energy necessary to bring the closure mechanism into its resting position as soon as the pressure loading of the actuation lever is absent. This is possible since the weight is raised by being swivelled and thus has increased potential energy. This means, according to the invention for the shifting of the device, for one, the kinetic energy of the fluids and, for another, the gravity of the earth is utilized. The distance of the weight from the swivel axle depending herein on the overall size of the closure mechanism, the kinetic energy of the fluids, the desired closure time and the mass of the closure mechanism. The disposition in a guide channel open on one end, leads at easy insertibility to a firm retention such that during operation it cannot be detached out of the connection through vibrations or repeated swivel movements.

A further development of the invention provides that the swivel axle is formed as a cross axle, which is preferably disposed within a guide channel closed on one end. Due to the structuring the swivel axle is torsion-loaded such that a cross axle is especially well suited to permit a stable and durable closure mechanism.

According to the invention it is further provided that swing arm, actuation lever and closure are comprised of a synthetic material suitable for food contact applications, in particular polyethylene. The weight is preferably comprised of V4A steel, which is also suitable for food contact applications.

In a further implementation of the invention the closure comprises a channel, preferably in the form of a Y, which has a slight gradient and which terminates at a preferably semicircular outlet opening of the outlet sleeve. This implementation permits at great advantage the discharge of possible residual afterflow fluids from the sleeve such that caking cannot occur within the sleeve, which, again, would be of concern from the aspect of hygiene.

Alternatively, or supplementally, the closure can have a multiplicity of sieve-like holes from which is discharged a residual afterflow fluid. This is in particular possible in the case of non-carbonated beverages, since here the surface tension is so low that they can flow out through the holes, whereas in the case of the former beverages, blockages can occur.

An implementation of the invention provides that the actuation lever includes a coaxial opening which is suitable for receiving a syrup nozzle. This coaxial opening can be a bore or a cutout, wherein the particular diameter can be freely selected depending on the different syrup nozzles. The device according to the invention can hereby be applied to the most diverse soft drink and postmix systems. According to the invention the actuation lever can have a conical shell cooperating with a conical seat of the outlet sleeve. In this case a tight closing between actuation lever and outlet sleeve inner wall results such that the entire kinetic energy of the entire fluid quantity is as much as possible utilized for the opening movement. However, according to the invention it is also provided to provide the actuation lever at a spacing from the outlet sleeve inner wall such that an annular opening between actuation lever and outlet sleeve inner wall results through which a portion of streaming fluid can exit without actuating the closure mechanism. The inner wall is hereby rinsed and kept free of syrup residues.

The sleeve is a sleeve which is disposed on present soft drink and postmix systems by means of bayonet joint.

This sleeve is comprised of a body, a counterweight with closure, an inner fork as well as a movement axle.

This sleeve is suitable for mechanical or electronic beverage dispensers.

As soon as a glass is placed into the tray of the soft drink or postmix system, a mechanism is triggered in the interior of the sleeve. The water flows onto the inner fork, which, in turn, actuates the movement axle. The syrup dispenser located within the apparatus ejects the necessary quantity of syrup and this syrup is mixed with the water in the lower region of the sleeve. Through the water pressure onto the inner fork the closure cover opens and the soft drink flows into the glass. As soon as an apportioned quantity of liquid is in the glass, the closure cover closes automatically and the glass can be removed from the tray. This sleeve closes the outlet completely tightly and penetration of bees, wasps, ants and other pests is no longer possible.

The invention will be described by example in a preferred embodiment with reference to a drawing, wherein further advantageous details can be found in the Figures of the drawing.

Functionally identical parts are provided with identical reference numbers.

The Figures of the drawing depict in detail:

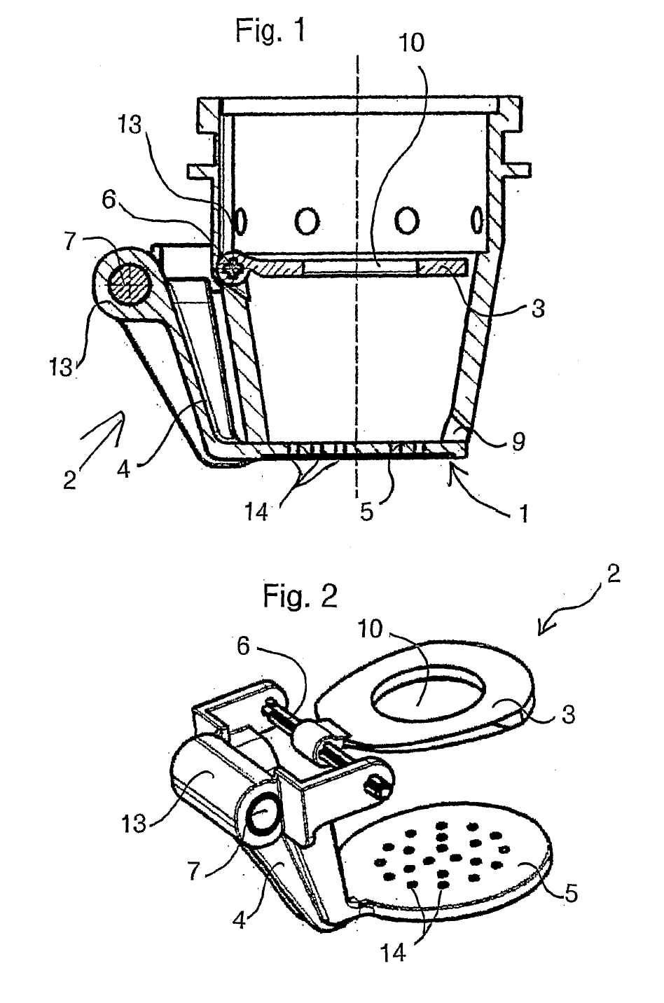

FIG. 1: a cross section through an outlet sleeve according to the invention with assembled closure device,

FIG. 2: a perspective view of the closure mechanism in the disassembled state,

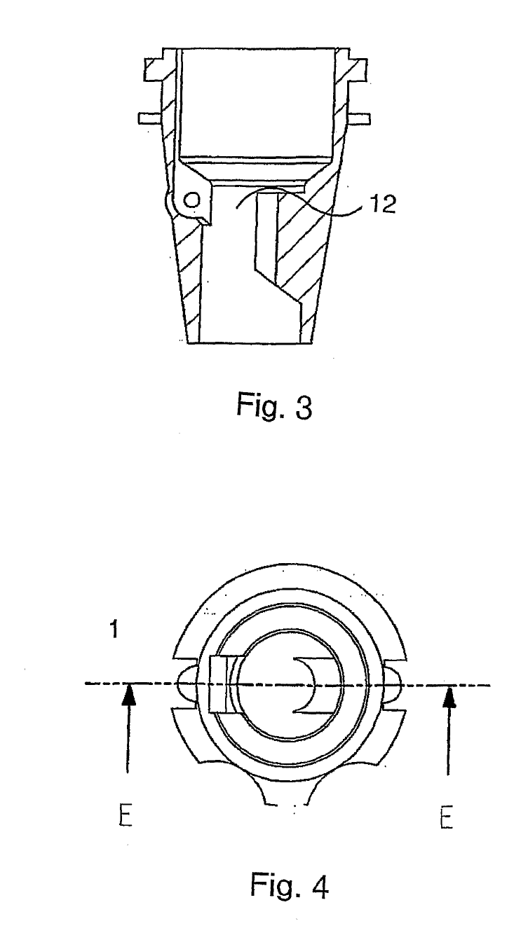

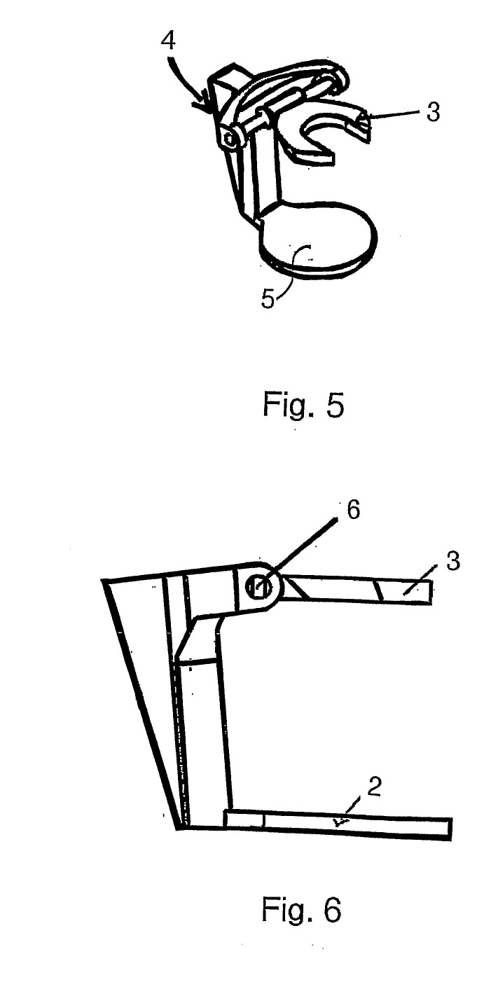

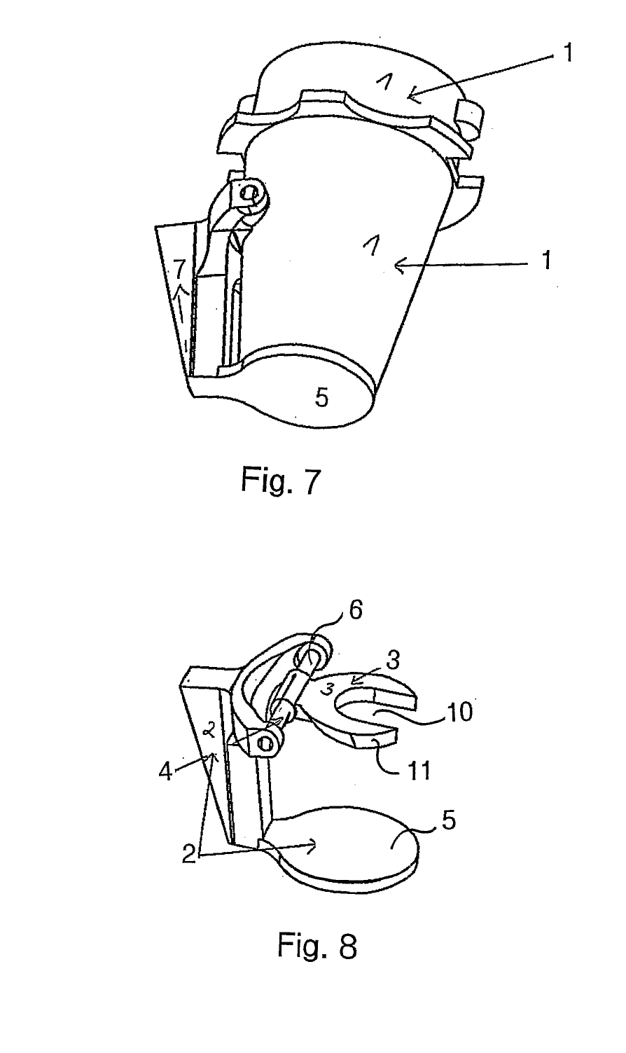

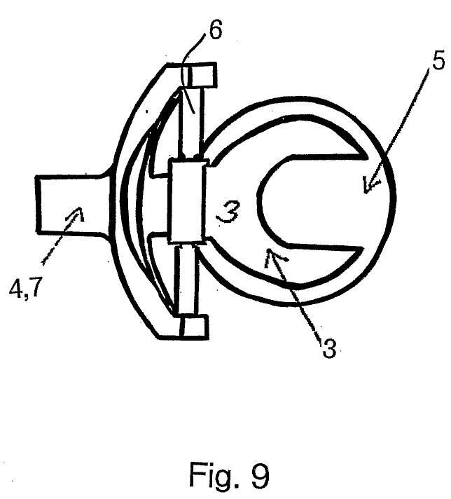

FIGS. 3 to 9: several views of further embodiments.

FIG. 1 shows a cross section through an outlet sleeve 1 according to the invention with installed closure device 2. The outlet sleeve 1 is comprised of a cylindrical portion and a conical portion adjoining thereon, which in the cylindrical portion includes the customary projections for fastening, for example in the manner of a bayonet joint, on soft drink or postmix systems. In the transition region between cylindrical and conical portion is located the actuation lever 3 having a coaxial opening 10 which, in this case, is formed as a circular bore. The actuation lever 3 includes an eye through which penetrates the cross axle 6. The eye is located in the interior of the outlet sleeve 1. In the assembled state a syrup discharge nozzle penetrates through the coaxial opening 10. On the cross axle 6 a swing arm 4 is torsion-tight connected with two arms, at whose lower end, at an angle to the swing arm, a closure 5 is disposed. The swing arm 4 includes in a guide channel 13 a weight 7 comprised of V4A steel. The guide channel 13 is formed as a pocket bore. However, according to the invention it is also conceivable, instead of a weight 7 to be inserted separately, to provide the swing arm as one piece with increased mass, for example by injection-molding a metal body or using a significantly denser material than polyethylene. FIG. 1 shows the resting state of the closure device, in which the closure 5 is in close contact on the lower edge of the sleeve 1. Only through a semicircular outlet opening 9 does it become possible that potentially residual afterflow fluid can leave the sleeve. According to the invention, apart from this outlet opening 9, a multiplicity of holes 14 can yet be added in the closure such that it is ensured that no beverage residues remain in the interior of the sleeve.

When drawing a soft drink, first, water flows out which to an extent acts upon the actuation lever 3 and to a lesser extent penetrates laterally of it through a gap between the actuation lever and the inner wall of the outlet sleeve. By acting upon the actuation lever 3, this lever is moved downwardly, and, due to the torsion-tight connection with the cross axle 6, rotates this axle in the clockwise direction. Due to the torsion-tight connection of the swing arm 4 with this cross axle, this lever is swivelled and consequently the weight 7 is raised on a circular path which leads in the direction of the outer margin of the cylindrical portion of the outlet sleeve 1. Due to the rigid linkage of the closure 5, this closure is also moved away on a circular path from the lower end of the outlet sleeve 1 and consequently clears it. Thereafter syrup exits from the syrup discharge nozzle, and is mixed with the water in a glass located under the device. Shortly before the end of the drawing process the syrup exit is terminated such that only water flows out in order to clean the interior of the sleeve. After this flow of water is also stopped, fluid no longer acts upon the actuation lever 3. Due to the shifted center of gravity and the increased potential energy of the metal weight 7, now a closure movement takes place, in which the swing arm 4 swivels back into its starting position entraining the actuation lever 3, and, consequently, closes the outlet opening again with the closure 5. Liquid, possibly still in the sleeve or residually after-flowing, can either exit through the holes 14 or through the outlet opening 9, wherein, for this purpose, also a channel, not shown, can be provided in closure 5.

FIG. 2 shows the disassembled closure mechanism 2 in a variant with holes 14 in closure 5. Readily evident is the torsion-tight connection of actuation lever 3 and swing arm 4 of the cross axle 6. The latter penetrates not only through these two structural parts but also a channel 13 formed onto sleeve 1.

Instead of a metal weight 7, in FIGS. 3, 4, 7, 8, 9 a region of increased mass of the swing arm 4 is provided. This mass region is provided as a wedge-form region. The actuation lever 3 has a coaxial opening 10 which in this case is developed as a cutout such that the actuation lever 3 has a bifurcated end. Shown is also a conical surface 11 cooperating with a conical seat 12. The cone is herein developed in each case such that it permits downward movement.

### List of Reference Numbers

1 Outlet sleeve
2 Closure mechanism
3 Actuation lever

### 4 Swing arm

### 5 Closure

6 Swivel axle

### 7 Weight

### 8 Channel

9 Outlet opening
10 Coaxial opening

### 11 Shell

### 12 Seat

13 Guide channel
14 Holes

1. Outlet sleeve (1) of soft drink and postmix systems, characterized in that it comprises a closure mechanism (2), in particular a self-actingly operating closure mechanism (2).

2. Outlet sleeve (1) as claimed in claim 1, characterized in that the closure mechanism (2) comprises an actuation lever (3) in the interior of the outlet sleeve (1), a force transmitter (4) and a closure (5), wherein the actuation lever (3) can be acted upon by at least one fluid.

3. Outlet sleeve as claimed in claim 1, characterized in that the actuation lever (3) and the force transmitter (4) are developed as rigid levers, wherein the force transmitter (4) is developed as a swing arm (4), wherein actuation lever (3) and swing arm (4) are disposed on a swivel axle (6) and/or the closure (5) is disposed on the swing arm (4).

4. Outlet sleeve as claimed in claim 1, characterized in that in the proximity of the swivel axle (6) is disposed a weight (7), which is preferably disposed in a guide channel (13) open at one end.

5. Outlet sleeve as claimed in claim 1, characterized in that the swivel axle (6) is developed as a cross axle, which is preferably disposed within a guide channel (13′) open at one end.

6. Outlet sleeve as claimed in claim 1, characterized in that actuation lever (3), swing arm (4) and closure (5) are comprised of a synthetic material suitable for food contact applications, in particular polyethylene, and/or the weight (7) is comprised of V4A steel.

7. Outlet sleeve as claimed in claim 1, characterized in that the closure (5) comprises a channel (8), preferably in the form of a Y, which has a slight gradient and which terminates at a preferably semicircular outlet opening (9) of the outlet sleeve (1).

8. Outlet sleeve as claimed in claim 7, characterized in that the closure (5) comprises a multiplicity of sieve-like holes (14).

9. Outlet sleeve as claimed in claim 1, characterized in that the actuation lever (3) includes a coaxial opening (10) suitable for receiving a syrup nozzle and/or a conical shell (11) for the cooperation with a conical seat (12) of the outlet sleeve (1).

10. Body for soft drink and postmix systems, characterized in that the body has a movement axle.

11. Device as claimed in claim 10, characterized in that on the movement axle a counterweight with closure is disposed.

12. Device as claimed in claim 10, characterized in that on the movement axle in the interior of the body an inner fork is disposed and the inner fork through water pressure sets the entire mechanism into movement such that the closure opens.
